(19) United States
(12) Patent Application Publication
(10) Pub. No.: US 2006/0204781 A1
(43) Pub. Date: Sep. 14, 2006

(54) Component for optical device

(76) Inventor: Kenzo Takei, Nagano (JP)

Correspondence Address: FLYNN THIEL BOUTELL & TANIS, P.C., 2026 RAMBLING ROAD, KALAMAZOO, MI, 49008-1631, US

(21) Appl. No.: 10/544,728

(22) PCT Filed: Feb. 12, 2004
(86) PCT No.: PCT/JP04/01502

§ 371 Date: Aug. 4, 2005

(30) Foreign Application Priority Data
Feb. 14, 2003 (JP) 2003-36139

(51) Int. Cl. C04B 28/26; B32B 9/00

(52) U.S. Cl. 428/688; 106/608; 428/702

(57) ABSTRACT

A component for optical devices which is a molded product produced by molding and then curing a molding material containing a cement material with hydration reactivity is disclosed. Such a component can be used as, for example, a housing of segment displays or projection displays, a reflector, an optical recording medium, or an optical component-supporting member in optical heads.

### TECHNICAL FIELD

The present invention relates to a component for various types of optical devices in various types of optical devices such as, for example, a housing for a segment display or a projection-type display, a reflector, an optical recording medium, and an optical component supporting member of an optical head device.

### BACKGROUND

A housing of a segment display or projection-type display, and the like have been formed of resin mold product, whereas a housing of light source lamps, and the like have been formed of metal.

Resin can be produced into various forms by molding with ease and at low costs, but it has a disadvantage of its poor heat resistance. Metal, on the other hand, has a problem of its high thermal expansion. These drawbacks are undesirable for optical devices in particular, because they cause decrease in display performance, decrease in utilization of light, and decrease in precision of recording and reproducing of information by means of light.

In view of the above-discussed problems, an object of the present invention is to provide components for optical devices free of problems, such as low heat resistance and deformation, which conventional resin molded products and metallic products have had.

### DISCLOSURE OF THE INVENTION

In order to solve the above-described problem, according to the present invention, an optical device component for various types of optical devices is a ceramic molded product produced by molding a molding material including a cement material having hydration reactivity into a desired shape, and then curing it.

In the present invention, a term “cement material having hydration reactivity” means not only a cement material which cures upon addition of water thereto, but also a cement material curable by its own hydration reactivity without addition of water by means of surface-treatment and the like. The cement material which can cure by its own hydration reactivity without addition of water may be prepared by, for example, a cement material which has been subjected to hydration reaction beforehand and added with a cross-linking resin.

According to the present invention, since the cement material is molded in a mold and the like, manufacturing without wasting the material, with high productivity and at low cost can be realized. Further, such molded products, when used for manufacturing the component for optical devices such as a housing for a segment display or a projection-type display, a reflector for a light source lamp unit, an optical recording medium, and an optical component supporting member for an optical head device, are not deformed by environmental temperature changes or heat generated by light sources, and, therefore, can maintain satisfactory performance. When the molded product is used as the reflector for the light source lamp unit, light utilization efficiency increases because there occurs no deformation of the molded product. Also, when it is used as the optical recording medium or the optical component supporting member for the optical head device, precision of recording and recording of information can be improved.

It is preferable to add a thermoplastic resin such as polypropylene, polystyrene, polyamide, polyethylene terephthalate, and polyphenylene sulfide to the cement material or the molding material of the present invention. With such composition, when the materials are mixed in a molding machine, the thermoplastic resin is softened or melted due to heat generated during mixing, fluidity of the material moving from the molding machine into the mold is improved. In view of melting temperature and heat resistance and the like, the use of polypropylene or polystyrene as the thermoplastic resin is preferable.

According to the present invention, it is preferable to add inorganic fibers such as glass fibers and carbon fibers, to the cement material or the molding material. Such composition can increase the strength of the ceramic molded products.

The component for optical devices according to the present invention can be used as a housing for a display with optical components thereof held by the ceramic molded products formed into a housing-shape.

The component for optical devices according to the present invention can be used as a reflector formed with a reflecting surface on the front side of a reflector body formed of the ceramic molded product which is shaped so as to cover the rear side of a light source.

The component for optical devices according to the present invention can be used as an optical recording medium, in which has a layer of an optical recording material is formed on one surface of the component for optical devices formed into a shape of substrate.

The component for optical devices according to the present invention can be used as an optical element supporting member on which various types of optical components for an optical head device are mounted.

### BRIEF DESCRIPTION OF THE DRAWINGS

FIG. 1 is an explanatory view of a segment display as an optical device according to the present invention.

FIG. 2 is an explanatory view of a liquid crystal projector as an optical device according to the present invention.

FIG. 3 is an explanatory view of an optical recording medium according to the present invention.

FIG. 4 is an explanatory view of an optical head device according to the present invention.

(Explanation of Reference Numerals)

10 Segment Display (Optical Device)

11 Light-Emitting Elements

13 Transmission Windows

14 Housing (Component for Optical Device)

20 Liquid-Crystal Projector (Optical Device)

21 Light source Unit

28 Light source Lamp

29 Reflector (Component for Optical Device)

32 Display Section

40 Optical Recording Medium (Component for Optical Device)

41 Substrate

43 Recording Layer

42, 44 Protective Layers

50 Optical Head Device

52 Lens Holder (Optical Component Supporting Member/Component for Optical Device)

55 Device Frame (Optical Component Supporting Member/Component for Optical Device)

### BEST MODE FOR CARRYING OUT THE INVENTION

Hereinafter, embodiments of the present invention are described.

[Producing Method 1]

According to the present invention, as a cement material having hydration reactivity, a molding material composed of the under-mentioned cement material with water added thereto, or hydrothermally synthesized ceramic, having a trade name of “Z-ma” and commercially available from Sumitomo Osaka Cement Co., Ltd., is used to produce the later-mentioned ceramic molded products, that is components for optical devices such as housings for segment displays and projection-type displays, reflectors for light source lamp units, optical recording mediums, and components for optical head devices.

An example of the molding material is as follows.

| | | |
|---|---|---|
| Cement Material: | 100 | parts by weight |
| Hydraulic Powder (Portland Cement): | 40-80% | by weight |
| Non-hydraulic Powder (Silica Fume): | 10-50% | by weight |
| Moldability Improving Agent (Talc): | 10-30% | by weight |
| Processability Improving Agent | 2-9 | parts by weight |
| (Acrylic Resin): | | |
| Thickener (Carboxymethyl Cellulose): | 0.5-5 | parts by weight |
| Water: | 25 | parts by weight |

The cement material includes hydraulic powder, and non-hydraulic powder, moldability improving agent, a processability improving agent, a thickener, a filler etc. may also be optionally added. For example, the cement material may include 40%-80% by weight of hydraulic powder, 10%-50% by weight of non-hydraulic powder, and 10%-30% by weight of moldability improving agent, 2-9 parts by weight, relative to 100 parts by weight of the mixture powder, of processability improving agent, and 0.5-5 parts by weight of thickener.

The hydraulic powder is, for example, calcium silicate compound powder, calcium aluminate compound powder, calcium fluoroaluminate compound powder, calcium sulfoaluminate compound powder, calcium aluminoferrite compound powder, calcium phosphate powder, hemihydrate or anhydrous gypsum powder, or self-curing calcined lime powder, which can be cured by water. Typical hydraulic powder is Portland cement, for example.

The non-hydraulic powder is powder, which is not be cured alone even when it is brought into contact with water. Typical examples include calcium hydroxide powder, gypsum dehydrate powder, calcium carbonate powder, slag powder, fly ash powder, silica powder, clay powder, silica fume powder, and the like. Addition of such non-hydraulic powder increases a filling ratio during molding of molded products, and reduction of voids in the resulting molded products can be achieved. This improves dimensional stability of molded products.

The moldability improving agent is a material which improves slip property of the product relative to a mold during injection molding, and reduces anisotropy in moldability, and thereby provides stabilization of quality. Examples of the moldability improving agent include inorganic materials such as talc (hydrous magnesium silicate) and mica. Such inorganic materials have good orientation and give slip property to the surface of the molded products, and reduce friction relative to the mold, resulting in quality stabilization.

The processability improving agent contributes to improving moldability, releasing, machinability and grindability of the ceramic molded products and also improving precision of grinding. A composite resulted from adding the processability improving agent has an improved moldability because the processability improving agent serves as a molding assistant during pressure molding. Furthermore, the processability improving agent reduces brittleness of the ceramic molded products, and, therefore, the resulting molded products can be released from the molds without being damaged. This results in improvement in yield and workability. Also, the addition of the processability improving agent avoids cracking, chipping, and the like. This makes it possible to process the hydraulic composition, like metallic materials, by cutting and grinding using machining devices such as a lathe. Examples of such processability improving agents include vinyl acetate resin or vinyl acetate copolymer resin, acrylic resin or acryl copolymer resin, styrene resin or styrene copolymer resin, epoxy resin, and the like.

The thickener is a material which develops tackiness when dissolved into water, and is effective to increase bond between particles of the hydraulic and non-hydraulic powders, and effectively maintain the shape and water retention property of the ceramic products immediately after the molding, whereby dense and solid cured products can be formed. Examples of the thickener include methyl cellulose, hydroxyethyl cellulose, carboxymethyl cellulose, and the like.

In preparing the molding material using the cement material, water in an amount of 30 parts or less by weight, preferably 25 parts or less by weight, is added to 100 parts by weight of the cement material consisting of the hydraulic powder, the non-hydraulic powder, and the moldability improving agent, in addition to the above-described constituents. The amount of water to be added should be reduced in order to reduce shrinkage on drying.

In producing various molded products from the above-described molding material, the material is first molded into a desired shape by an injection molding machine and the like, and then the resulting ceramic products are cured.

The ceramic products thus produced are used as various components without or with additional machining provided thereto. According to this embodiment, the cement material is used to produce members formed of inorganic materials by molding. Therefore, the material can be less wasted than cutting and the like is employed, and higher productivity can be achieved. Thus, various components can be manufactured at a low cost.

[Producing Method 2]

In this embodiment, for example, several to several tens of percent of thermoplastic resin such as polypropylene, polystyrene, polyamide, polyethylene terephthalate, and polyphenylene sulfide, is added, in the form of pellets, flakes or powder, to the cement material or the molding material consisting of the cement material and water added to it, as described in the Producing Method 1, to produce later-described ceramic products, that is components for optical devices such as a housing for a segment display or a projection-type display, a reflector for a light source lamp, an optical recording medium, and a component of an optical head device.

When the molding material is mixed in an injection molding machine, being given heat and pressure, the thermoplastic resin is softened or melted due to the heat, so that fluidity of the molding material increases. As a result, pouring of the molding material into molds improves, so that ceramic molded products having good dimensional precision can be produced. Furthermore, when extrusion molding is employed, high fluidity of the molding material results in advantages, such as increase of dimensional precision when the molded product is extruded from a die.

[Producing Method 3]

In this embodiment, several to several tens of percent, for example, of inorganic fibers such as glass fibers and carbon fibers, prepared to have a required size, is added to the cement material or the molding material consisting of the cement material and water added thereto, as described in the Producing Methods 1 and 2, to produce the later-described ceramic products, that is components for optical devices such as a housing for a segment display or a projection-type display, a reflector for a light source lamp, an optical recording medium, and a component of an optical head device.

With this arrangement, the strength of the molded products using the cement material is improved, and therefore cracking and chipping of the products can be prevented.

[Producing Method 4]

In this embodiment, several to several tens of percent of metal or metal compound powder is added to the cement material or the molding material consisting of the cement material and water added thereto, as described in the Producing Methods 1, 2 and 3. The mixture is subjected to injection molding. The resulting molded products are then cured and, if necessary, machined to produce the later-described ceramic products, that is components for optical devices such as a housing for a segment display or a projection-type display, a reflector for a light source lamp, an optical recording medium, and a component of an optical head device.

The metal or metal compound powder to be added is ferrous powder or ferrous compound powder such as iron powder, stainless steel powder, Permalloy powder, sendust powder, iron oxide powder and magnetic material powder. Coppery powder such as copper powder, brass powder, nickel silver powder, phosphor bronze powder, and copper titanium powder can also be added as the metal or metal compound powder. Other than the above-described ferrous or coppery powder, metal powder such as aluminum powder, magnesium powder, nickel powder, tantalum powder, molybdenum powder, tin powder, lead powder, zinc powder, titanium powder, chromium powder, zirconium powder, and cobalt powder, may be added as the metal or metal compound powder. Also, silicon powder can be used.

According to this embodiment, in producing various ceramic molded products from these materials, the molding material is prepared by mixing the following materials, for example.

| | | |
|---|---|---|
| Cement Material: | 100 | parts by weight |
| Hydraulic Powder (Portland Cement): | 40-80% | by weight |
| Non-hydraulic Powder (Silica Fume): | 10-50% | by weight |
| Moldability Improving Agent (Talc): | 10-30% | by weight |
| Processability Improving Agent | 2-9 | parts by weight |
| (Acrylic Resin): | | |
| Thickener (Carboxymethyl Cellulose): | 0.5-5 | parts by weight |
| Powder: | | |
| Metal Powder or Metal Compound | 10 | parts by weight |
| Water: | 25 | parts by weight |

[Producing Method 5]

According to this embodiment, metal powder is added to the cement material or the molding material consisting of the cement material and water added thereto, as described in the Producing Methods 1, 2 and 3. The mixture is subjected to injection molding. The resulting molded products are then cured and, if necessary, machined. After that, the metal powder is nitrided, sulfurated, or carburized, and the later-described ceramic products, that is components for optical devices such as a housing for a segment display or a projection-type display, a reflector for a light source lamp, an optical recording medium, and a component of an optical head device, are produced.

The powder of metal to be added is ferrous or ferrous compound powder such as iron powder, stainless steel powder, Permalloy powder, sendust powder, iron oxide powder, and magnetic material powder.

In this embodiment, in producing various ceramic molded products from these materials, the molding material is prepared by mixing the following materials, for example.

| | | |
|---|---|---|
| Cement Material: | 100 | parts by weight |
| Hydraulic Powder (Portland Cement): | 40-80% | by weight |
| Non-hydraulic Powder (Silica Fume): | 10-50% | by weight |
| Moldability Improving Agent (Talc): | 10-30% | by weight |
| Processability Improving Agent | 2-9 | parts by weight |
| (Acrylic Resin): | | |
| Thickener (Carboxymethyl Cellulose): | 0.5-5 | parts by weight |
| Ferrous Metal Powder: | 10 | parts by weight |
| Water: | 25 | parts by weight |

[Application to Segment Display]

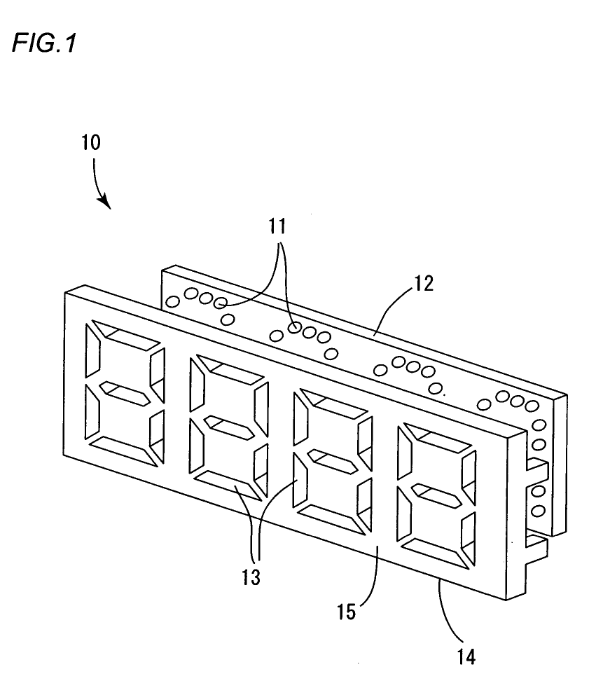

FIG. 1 is an explanatory view of a segment display as an optical device according to the present invention.

In FIG. 1, a segment display 10 includes a substrate 12 with a plurality of light-emitting elements 11 such as light-emitting diodes, phototransistors, and CdS cells, mounted thereon at predetermined locations, and a housing 14 formed with a plurality of transmission windows 13 in which the light-emitting devices 11 are disposed. The segment display 10 can display required information by controlling the turning on and off of the light-emitting elements 11 disposed in the respective transmission windows 13.

As the housing 14 (an component for an optical device) of the segment display 10, a resin molded product has been conventionally used. This embodiment, however, uses a white ceramic molded product with a front surface 15 painted in black or in other color, prepared by molding a molding material, formed of a cement material and water added thereto, into a desired shape, then, curing it, as described in the Producing Methods 1 through 5. Accordingly, even when the housing 14 is formed from an inorganic material, it can be produced without wasting the material, with high productivity and at a low cost. Furthermore, such ceramic molded products are not deformed by environmental temperature changes, and therefore can maintain good display performance. Also, unlike resin products, the housing 14 according to this embodiment is free from crosslinking reaction or decomposition reaction caused by ultraviolet radiation, and therefore it is highly weather-resistant. Hence, the housing 14 can be used as a display for outdoor use. The housing 14 of the present embodiment, even when it is white, has good heat-resistance and weather-resistance, it can exhibit reflectivity higher by about 30% or more than resin products, and, therefore, it can advantageously secure a sufficient amount of light for display.

[Application to Liquid Crystal Projector]

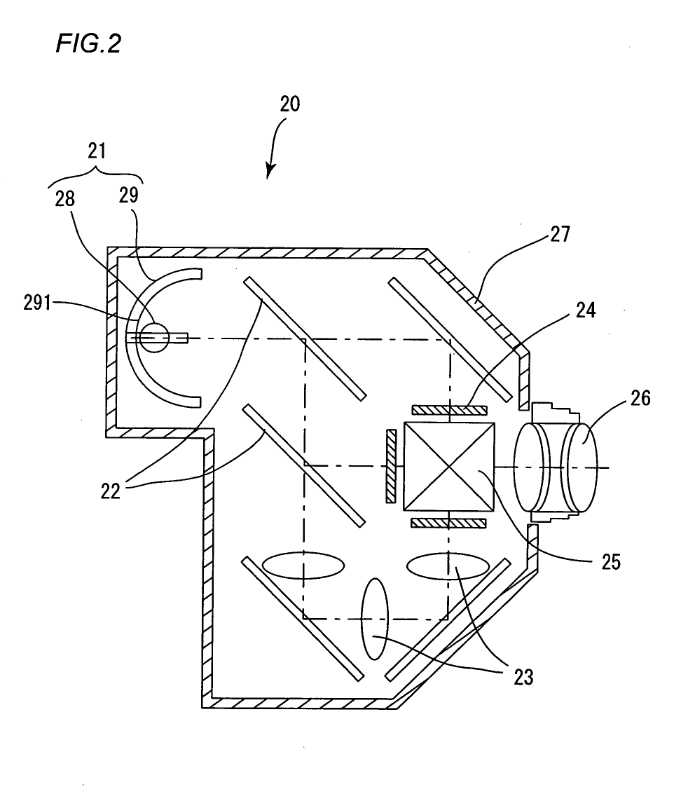

FIG. 2 is an explanatory view of a liquid crystal projector (a projection type display) as an optical device according to the present invention.

In FIG. 2, in a liquid crystal projector 20, white light emitted from a light source unit 21 is separated into the three primary colors of red, green and blue, by dichroic mirrors 22 and condenser lenses 23, and the three color lights are led to three liquid crystal light valves 24, where they are individually modulated for respective colors. After that, these three color lights are combined in a dichroic prism 25 and projected through a projection lens 26. Being wholly or partly housed in a light-guide (not shown), the optical system is housed in a housing 27, which is sometimes called lamp housing. The light source unit 21 includes a light source lamp 28 such as a halogen lamp, a short-arc metal halide lamp, a xenon short-arc lamp, and a super high-pressure mercury lamp, a reflector 29 having a curved reflecting surface 291 on its inner surface, and a lamp housing (not shown).

A resin molded product has been conventionally used for the housing 27 (a component for an optical devices) or the light-guide (a component for an optical devices) of such liquid crystal projector 20. The present embodiment, however, uses a ceramic molded product prepared by molding a molding material, consisting of a cement material with water added thereto, into a desired shape, and then curing it, as described in the Producing Methods 1 through 5. Accordingly, even when an inorganic material is used to form the housing, it can be produced without wasting the material, with high productivity and at a low cost. Furthermore, such ceramic molded products have resistance against heat of from 270 degrees to 500 degrees and, therefore, are not deformed due to environmental temperature changes or heat generated by the light source. Accordingly, even when the liquid crystal projector 20 is downsized by highly integrating its optical components, it can have its optical axis undistorted, for example, and can maintain good display performance. Also, unlike resin products, the housing according to this embodiment is free from crosslinking reaction or decomposition reaction caused by ultraviolet radiation, and therefore exhibits improved weather-resistance.

Also, in the present embodiment, the light source unit 21 uses the reflector 29 (a component for an optical device) with the reflecting surface 291 produced by flame spraying a metal over the inner surface of a ceramic molded product prepared by molding a molding material, consisting of a cement material with water added to it, into a desired shape and, then, curing it, as described in the Producing Methods 1 through 5. Since the inner surface of the molded product is the surface with which a mold is contacting during the molding processing, it is smooth, and therefore the reflecting surface 291 can be formed simply by flame spraying the metal over it. Alternatively, the reflecting surface 291 may be formed by providing mirror finishing to the inner surface and flame-spraying the metal after that.

Accordingly, even when the reflector 29 is formed of an inorganic material, it can be produced without wasting the material, with high productivity and at a low cost. Furthermore, such ceramic molded products are not deformed due to environmental temperature changes or heat generated by the light source, and therefore it can have its optical axis undistorted, for example, and can maintain good display performance.

[Application to Optical Recording Medium]

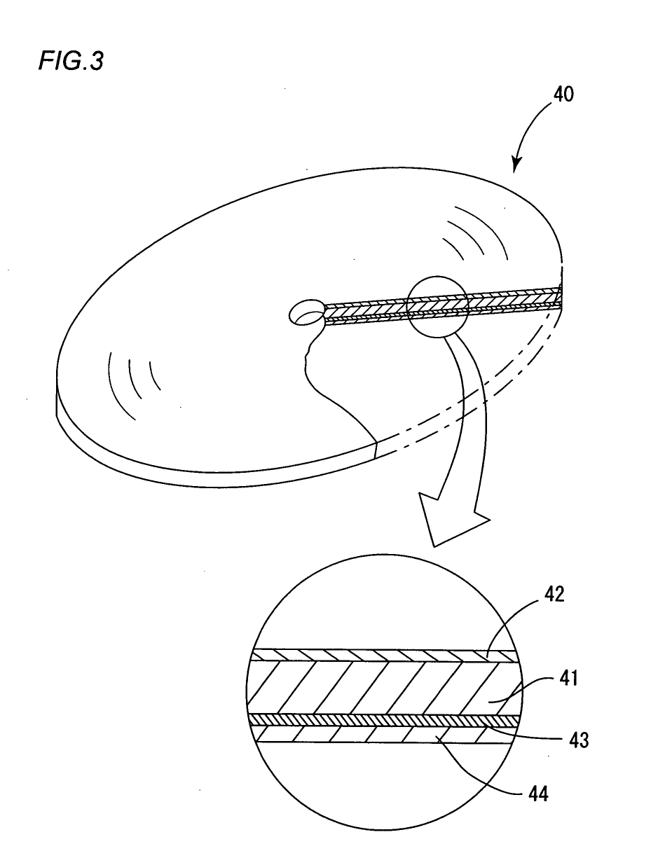

FIG. 3 is an explanatory view of an optical recording medium according to the present invention.

In FIG. 3, an optical recording medium 40 such as a CD, a CD-R, or a DVD includes a disc-shaped substrate 41, and a recording layer 43 and a protective layer 44 laminated in this order on the lower surface thereof.

An engineering plastic has been conventionally used for the substrate 41 of the optical recording medium 40. In the present embodiment, however, a ceramic molded product is used, which is prepared by molding a molding material consisting of a cement material with water added thereto, into a desired shape, and then curing it, as described in the Producing Methods 1 through 5. If necessary, the protective layer 42 may be provided on the upper surface of the substrate 41, and a label may be printed on the side where the protective layer 42 is formed.

In this embodiment, even when the substrate 41 of the optical recording medium 40 is formed of an inorganic material, it can be produced without wasting the material, with high productivity and at a low cost. Furthermore, such molded products are not deformed due to environmental temperature changes, and therefore reproduction and recording can be realized with high precision. Specifically, polyamide and polybutylene terephthalate, which are engineering plastics, have the respective linear expansion coefficient of about 30×10⁻⁶ and about 20×10⁻⁶, while that of a hydraulic ceramic is 5×10⁻⁶, which is about a quarter of those of the engineering plastics. Iron has a linear expansion coefficient of about 12×10⁻⁶, and therefore that of the hydraulic ceramic is about a half of iron.

Furthermore, unlike resin molded products, since no crosslinking or decomposition reaction due to ultraviolet radiation occurs in ceramic molded products, the optical recording medium including the ceramic molded product has no warpage in an initial stage immediately following the molding and after a predetermined period, and therefore it has a high degree of flatness.

Hydraulic ceramic has a specific gravity of about 2, which is large in comparison with that of resin (about 1.0), but is small in comparison with that of aluminum (about 2.7). Accordingly, stable rotation can be realized, which results in high precision in both reproduction and recording.

It should be noted that the present invention is applicable not only to optical recording mediums such as a CD and a DVD, but also to other various optical recording mediums (including optomagnetic recording mediums).

[Application to Optical Head Device]

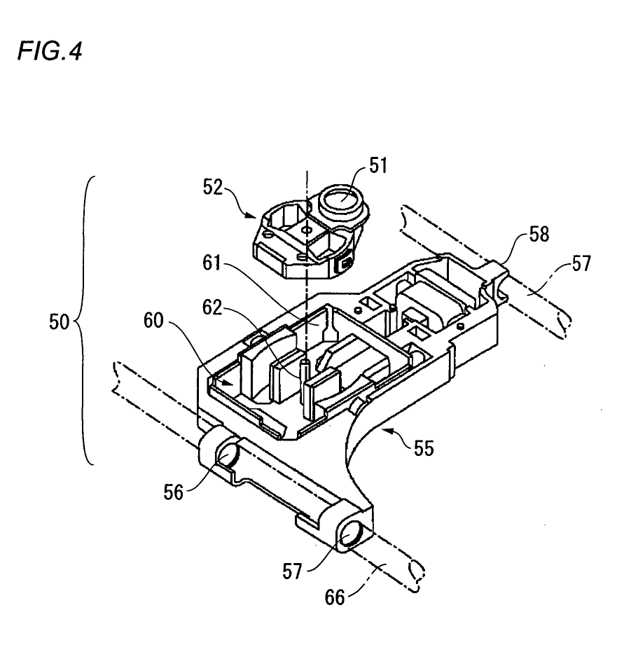

FIG. 4 is an exploded perspective view of an optical head device according to the present invention. An optical head device 50 shown in FIG. 4 is used in reproducing and recording from and into an optical recording disc such as a CD and a DVD. The optical head device 50 includes an objective lens 51 for focusing laser light onto an optical recording medium, a lens holder 52 holding the objective lens 51, a magnetically driven objective lens driver 60 for moving the lens holder 52 in a tracking direction and in a focusing direction, and a device frame 55 mounted with the objective lens driver 60.

The device frame 55 has slides 56, 57 and 58 formed on both sides, which slide along guide shafts 66 and 67, so that the device frame 55 moves in the radial direction of an optical recording disc 2 and the device frame 55. Various optical components comprising an optical system with the objective lens 51 are also mounted on the device frame 55.

The device frame 55 is provided with a through-hole, in which the objective lens driver 60 is mounted. The objective lens driver 60 includes an actuator yoke 61 which opens at an upper side, and a spindle 62 stands vertically from a center of a bottom plate thereof. The lens holder 52 is movable along the spindle 62 in the focusing direction and, at the same time, rotatable about the spindle 62 in the tracking direction.

A magnetic driver circuit for tracking and a magnetic driver circuit for focusing, each including a driving coil and a driving magnet, are disposed between the objective lens driver 60 and the lens holder 52.

In the present embodiment, for the device frame 55 (an optical component supporting member) or the lens holder 52 (an optical component supporting member), a ceramic molded product is used, which is prepared by molding a molding material, consisting of a cement material with water added thereto, into a desired shape and then curing it, as described in the Producing Methods 1 through 5. Such ceramic molded products are not deformed due to environmental temperature changes or heat generated by a light source, and therefore it can have its optical axis undistorted, for example, and can maintain good display performance. Also, since the device frame 55 and the lens holder 52 according to the present embodiment are formed of ceramic molded products, they are light in weight. Furthermore, the device frame 55 and the lens holder 52 are rigid, and therefore they have an advantage that no resonance occurs in their operating ranges.

The objective lens driver 60 is of a sliding and rotating type, but the present invention can also be applied to an optical head device of a system in which a lens holder is supported by wire-suspensions.

### OTHER EMBODIMENTS

In addition to the housings 14 and 27, the present invention can be applied to other components for optical devices such as frames for liquid crystal panels comprising displays of cellular phones and mobile computers, or frames for organic electroluminescent displays. Also, the present invention may be applied to housings for modularizing optical elements.

### INDUSTRIAL APPLICABILITY

As described above, according to the present invention, components for optical devices are molded from a cement material, and therefore components for optical devices such as housings for segment displays and projection-type displays, and reflectors for light source lamps can be produced without wasting materials, with high productivity, and at a low cost. Also, since components for optical devices formed of such ceramic molded products are not deformed by environmental temperature changes or by heat generated by light sources, the optical devices can maintain good display performance.

1. A component for an optical device, comprising a ceramic molded product produced by molding a molding material including at least a cement material having hydration reactivity into a desired shape, and, thereafter, curing the molded material.

2. The component for an optical device according to claim 1 wherein a thermoplastic resin is added to said cement material or to said molding material.

3. The component for an optical device according to claim 2 wherein said thermoplastic resin is polypropylene or polystyrene.

4. The component for an optical device according to claim 1 wherein inorganic fibers are added to said cement material or to said molding material.

5. A housing for a display comprising the component for an optical device defined by claim 1 wherein an optical component is held by said ceramic molded product formed into a housing shape.

6. A reflector comprising the component for an optical device defined by claim 1 wherein a reflecting surface is formed on a front surface of a reflector body formed of said ceramic molded product shaped so as to cover a rear side of a light source.

7. A recording medium comprising the component for an optical device defined by claim 1 wherein a layer of an optical recording material is formed on one of surfaces of said component for an optical device formed into a shape of substrate.

8. An optical component supporting member comprising the component for an optical device defined by claim 1 wherein optical components forming an optical system of an optical head device are mounted on said optical component supporting member.
